(19) United States
(12) Patent Application Publication
(10) Pub. No.: US 2011/0109924 A1
(43) Pub. Date: May 12, 2011

(54) LASER FIXING DEVICE AND IMAGE FORMING APPARATUS

(76) Inventor: Tomohiro MAEDA, Osaka-shi (JP)

(21) Appl. No.: 12/939,597

(22) Filed: Nov. 4, 2010

(30) Foreign Application Priority Data
Nov. 12, 2009 (JP) 2009-259246

(51) Int. Cl. H04N 1/60

(52) U.S. Cl. 358/1.9

(57) ABSTRACT

A fixing device includes: a laser radiating section for radiating laser light to a sheet so that a toner image on the sheet is fixed to the sheet, an optical sensor, and a smoke detecting section. The optical sensor includes a light radiating section for radiating light with a predetermined wavelength and a light receiving section for receiving the light with a predetermined wavelength so as to output a signal corresponding to a received amount of the light with a predetermined wavelength. The light radiating section and the light receiving section are positioned in such a manner that the light radiating section and the light receiving section face each other with a light path of the laser light therebetween, and light radiated from the light radiating section crosses the light path of the laser light and then reaches the light receiving section. The smoke detecting section detects smoke in the fixing device based on the signal. Thus, the laser fixing device can detect smoke with high accuracy.

This Nonprovisional application claims priority under 35 U.S.C. §119(a) on Patent Application No. 2009-259246 filed in Japan on Nov. 12, 2009, the entire contents of which are hereby incorporated by reference.

### TECHNICAL FIELD

The present invention relates to a fixing device for radiating laser light to a toner image transferred on a sheet so as to thermally fix the toner image on the sheet.

### BACKGROUND ART

An electrophotographic image forming apparatus includes a fixing device for thermally fusing a toner image on a sheet so as to fix the toner image on the sheet. An example of the fixing device is one employing a method for radiating light to an unfixed toner image on a sheet so as to thermally fuse the toner image and fix the toner image on a sheet (recording sheet). In the device employing this method, unlike a thermal roller fixing device, a toner image is heated without touching a heat source. Further, unlike a thermal roller fixing device, the device employing this method does not require warming up. As a device for fixing a toner image with light, Patent Literature 1 discloses a laser fixing device for fixing a toner image with use of a laser power. Patent Literature 1 describes a configuration in which a plurality of semiconductor lasers with low outputs are used and laser lights from respective light sources are focused on the same position so as to carry out a fixing process. Further, Patent Literature 1 describes that this fixing process can compensate for shortage of power when fixing a toner image and allows semiconductor lasers with low output and low costs to be used, thereby simplifying a configuration of the whole device.

In a case where a sheet catches fire due to excessively heating the sheet, a fixing device for fixing a toner image with light is required to swiftly recognize the fire and stop radiation of light. Examples of the cause for excessively heating a sheet include mulfunction of a driving device for driving a light source and defective conveyance of a sheet.

Patent Literature 2 discloses an image forming apparatus in which an air in a fixing device is caused to flow in a duct and an optical smoke detector provided in the duct detects generation of smoke (that is, the image forming apparatus recognizes fire by detecting generation of smoke).

Further, Patent Literature 3 discloses a flash fixing device including a lamp for radiating flashlight to a toner image on a sheet and a light receiving section for receiving scattered light when the flash light from the lamp is scattered. The flash fixing device determines whether smoke is generated or not based on a light intensity signal from the light receiving section by use of the fact that when smoke is emitted from a sheet, the flashlight is scattered by the smoke.

### Citation List

### [Patent Literatures]

[Patent Literature 1]

Japanese Patent Application Publication, Tokukai No. 2005-55516 A (published on Mar. 3, 2005)

[Patent Literature 2]

Japanese Patent Application Publication, Tokukaihei No. 7-319322 A (published on Dec. 8, 1995)

[Patent Literature 3]

Japanese Patent Application Publication, Tokukai No. 2008-70607 A (published on Mar. 27, 2008)

### SUMMARY OF INVENTION

### Technical Problem

However, in the fixing device of Patent Literature 3, where the scattered light travels to varies depending on the condition of smoke or the amount of smoke, and therefore there is case where the scattered light is not incident to a light receiving section even when smoke is emitted. This might make the fixing device unable to detect generation of smoke. That is, the fixing device of Patent Literature 3 suffers from a problem of low accuracy in detecting smoke emitted from a sheet.

The present invention was made in view of the foregoing problems. An object of the present invention is to provide a fixing device capable of detecting smoke with high accuracy.

### Solution to Problem

In order to solve the foregoing problem, a laser fixing device of the present invention includes: a conveying device for conveying a sheet; a laser radiating section for radiating laser light to a sheet conveyed by the conveying device so that a toner image on the sheet is fixed to the sheet; an optical sensor including a light radiating section for radiating light with a predetermined wavelength and a light receiving section for receiving the light with a predetermined wavelength so as to output a signal corresponding to a received amount of the light with a predetermined wavelength, the light radiating section and the light receiving section being positioned in such a manner that the light radiating section and the light receiving section face each other with a light path of the laser light therebetween, and light radiated from the light radiating section crosses the light path of the laser light and then reaches the light receiving section; and a smoke detecting section for detecting smoke in the laser fixing device based on the signal.

With the arrangement, light radiated from the light radiating section crosses the light path of the laser light and then reaches the light receiving section. When smoke is emitted from the sheet due to excessive radiation of laser light, smoke appears at the light path of the laser light. Consequently, the amount of light decreases when smoke is emitted than when smoke is not emitted. Therefore, when smoke is emitted from the sheet, the signal output from the light receiving section changes. Since the present invention is designed to detect smoke based on the signal, the present invention allows detecting smoke with high accuracy.

### Advantageous Effects of Invention

The present invention provides a laser fixing device capable of detecting smoke with high accuracy.

### BRIEF DESCRIPTION OF DRAWINGS

FIG. 1 is a drawing schematically showing a configuration of an image forming section and a fixing device which are included in a multifunctional printer in accordance with the present embodiment.

FIG. 2 is a drawing schematically showing a configuration of a fixing device in accordance with the present embodiment.

FIG. 3 is a drawing schematically showing the fixing device in FIG. 2 viewed from a side where a laser array is provided.

FIG. 4(a) is a drawing schematically showing a light receiving device and a light radiating device which are included in a transmission sensor.

FIG. 4(b) is a drawing showing the light receiving device in FIG. 4(a) viewed from a side of a light-receiving plane.

FIG. 5(a) is a drawing showing a pattern of an output of a transmission sensor when moisture is emitted. FIG. 5(b) is a drawing showing a pattern of an output of the transmission sensor when smoke is emitted.

FIG. 6 is a block diagram showing hardware included in a multifunctional printer in accordance with the present embodiment.

FIG. 7 is a flowchart showing processes carried out by a fixing control section in accordance with the present embodiment.

FIG. 8 is a flowchart showing processes carried out by a fixing control section in accordance with a modification example of the present embodiment.

FIG. 9 is an explanatory drawing showing a light path of light traveling from a light radiating device to a light receiving device.

### DESCRIPTION OF EMBODIMENTS

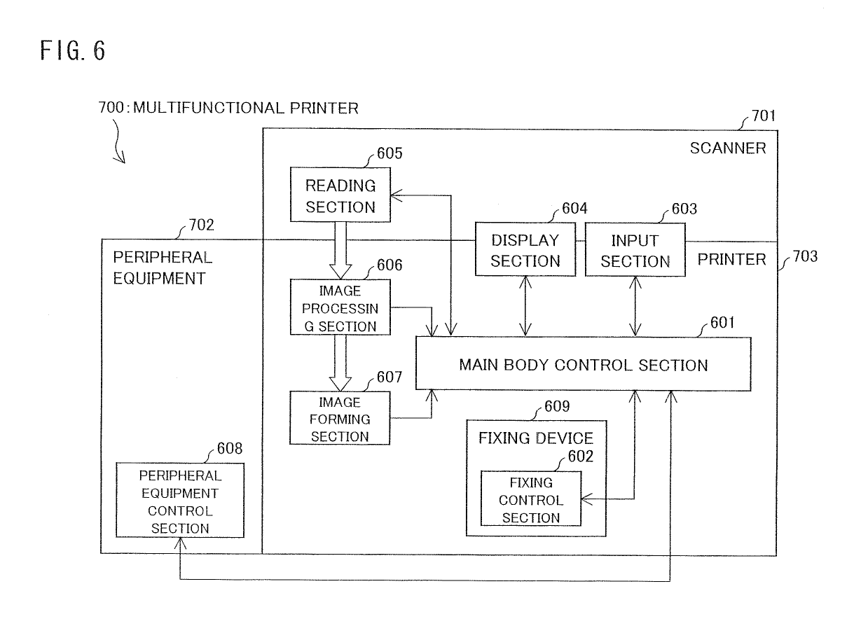

The following explains an embodiment of the present invention in detail. Initially, prior to an explanation regarding a fixing device of the present invention, an explanation is made as to a multifunctional printer (image forming apparatus) including the fixing device. FIG. 6 is a block diagram schematically showing a configuration of a multifunctional printer of the present embodiment.

A multifunctional printer 700 is an image forming apparatus having a scanner function, a copy function, a printer function, a facsimile function, an image filing function etc. As shown in FIG. 6, the multifunctional printer 700 includes a scanner 701, peripheral equipment 702, and a printer 703.

The scanner 701 includes a reading section 605 for reading a document so as to generate an image signal (analog signal).

The printer 703 is a dry electrophotographic and four-stage tandem color printer, and forms a multicolored (color) image or monochrome image on a sheet (recording sheet, recording member) based on image data transmitted from individual terminal devices on a network or based on image data of a document which is read by the reading section 605. The printer 703 includes: an image processing section 606 for performing various image processes on image data generated by the reading section 605 or image data transmitted from the terminal device; an image forming section 607 for transferring a toner image corresponding to the image data onto a sheet; a fixing device 609 for performing a fixing process on the sheet onto which the toner image has been transferred; and a main body control section 601 for totally controlling individual hardware included in the multifunctional printer 700.

The peripheral equipment 702 includes a post-process device such as a finisher and a sorter, and includes a peripheral equipment control section 608 for controlling the post-process device. Further, the multifunctional printer 700 includes: a display section 604 for displaying, to a user, various information concerning the multifunctional printer 700 and a preview of a printed image; and an input section 603 by which a user inputs various commands and various information to the multifunctional printer 700.

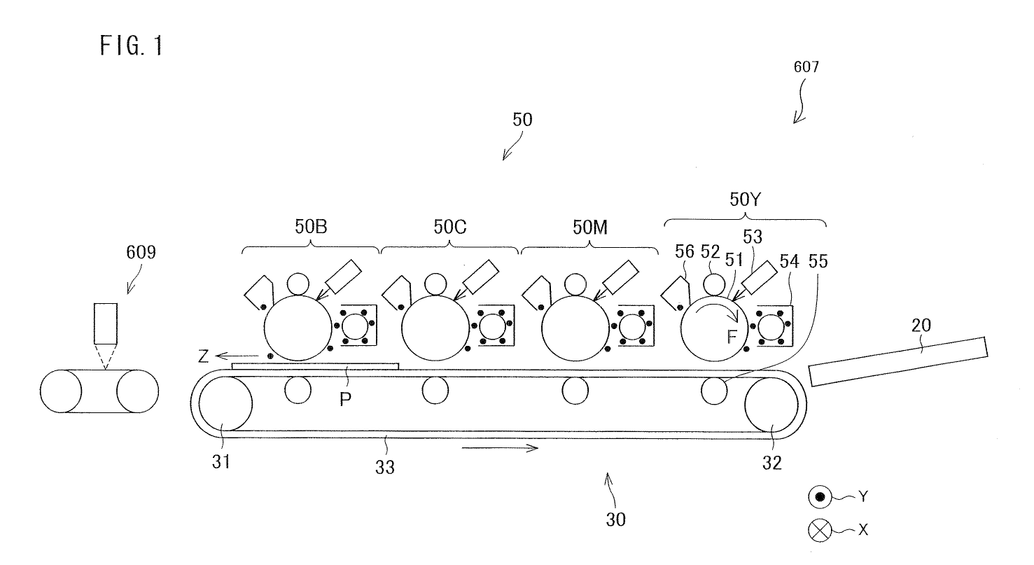

Next, the following specifically explains a configuration of the image forming apparatus 607. FIG. 1 is a drawing schematically showing the image forming section 607 and the fixing device 609 which are included in the multifunctional printer 700. As shown in FIG. 1, the image forming section 607 includes visible image forming units 50 (50Y, 50M, 50C, and 50B), a sheet conveying section 30, and a supply tray 20.

The image forming section 607 is provided with four visible image forming units 50Y, 50M, 50C, and 50B corresponding to yellow (Y), magenta (M), cyan (C), and black (B), respectively. Specifically, the visible image forming unit 50Y forms an image by using a yellow toner, the visible image forming unit 50M forms an image by using a magenta toner, the visible image forming unit 50C forms an image by using a cyan toner, and the visible image forming unit 50B forms an image by using a black toner. As shown in FIG. 1, the visible image forming units 50Y, 50M, 50C, and 50B are positioned in parallel with each other along a sheet conveyance path from the supply tray 20 where sheets P are loaded to the fixing device 609.

The following explains a configuration of the visible image forming unit 50Y. The visible image forming units 50Y, 50M, 50C, and 50B deal with different colors of toners but have substantially the same configuration. Accordingly, only an explanation of the configuration of the visible image forming unit 50Y is made below and explanations of the configurations of the visible image forming units 50M, 50C, and 50B are omitted here.

As shown in FIG. 1, the visible image forming unit 50Y includes a photoconductor drum 51, a charger 52, a light radiating device 53, a developing device 54, a transfer roller 55, and a cleaner unit 56.

The photoconductor drum 51 is a drum-shaped roller having a photoconductive material on its surface, rotates in an F direction shown in FIG. 1, and is capable of forming a toner image on its surface. The charger 52 evenly charges a surface of the photoconductor drum 51 with a predetermined potential. The light radiating device 53 radiates laser light onto the surface of the photoconductor drum 51 charged by the charger 52 in accordance with image data inputted to the image forming section 607, so as to form an electrostatic later image on the surface of the photoconductor drum 51. The developing device 54 makes the electrostatic latent image formed on the surface of the photoconductor drum 51 visible with a yellow toner. The transfer roller 55 is subjected to application of a bias voltage whose polarity is opposite to that of the toner, thereby transferring the toner image on the photoconductor drum 51 onto a sheet P in conveyance. The cleaner unit 56 removes and collects toner remaining on the surface of the photoconductor drum 51 after the development of the image by the developing device 54 and transferring of the image from the photoconductor drum 51.

The above processes are performed also by the visible image forming units 50M, 50C, and 50B, respectively. It should be noted that the developing device in the visible image forming unit 50M develops an image by using a magenta toner, the developing device in the visible image forming unit 50C develops an image by using a cyan toner, and the developing device in the visible image forming unit 50B develops an image by using a black toner.

The image forming section 607 as explained above is capable of superimposing a yellow image, a magenta image, a cyan image and a black image on the sheet P so as to form a full-colored image.

The following explains a sheet conveying section 30. As shown in FIG. 1, the sheet conveying section 30 includes a driving roller 31, an idling roller 32, and a conveying belt 33. The sheet conveying section 30 conveys the sheet P so that a toner image is formed on the sheet P in the visible image forming units 50. The conveying belt 33 is an endless belt and is tensioned by the driving roller 31 and the idling roller 32. A control section (not shown) rotates the driving roller 31 at a predetermined peripheral velocity, thereby rotating the conveying belt 33. Further, the external surface of the conveying belt 33 is charged electrostatically. Thus, the conveying belt 33 conveys the sheet P while the sheet P is attached to the conveying belt 33 due to the electrostatics. A toner image is transferred onto the sheet P and then the sheet P is detached from the conveying belt 33 due to a curvature of the driving roller 31 and is conveyed to the fixing device 609.

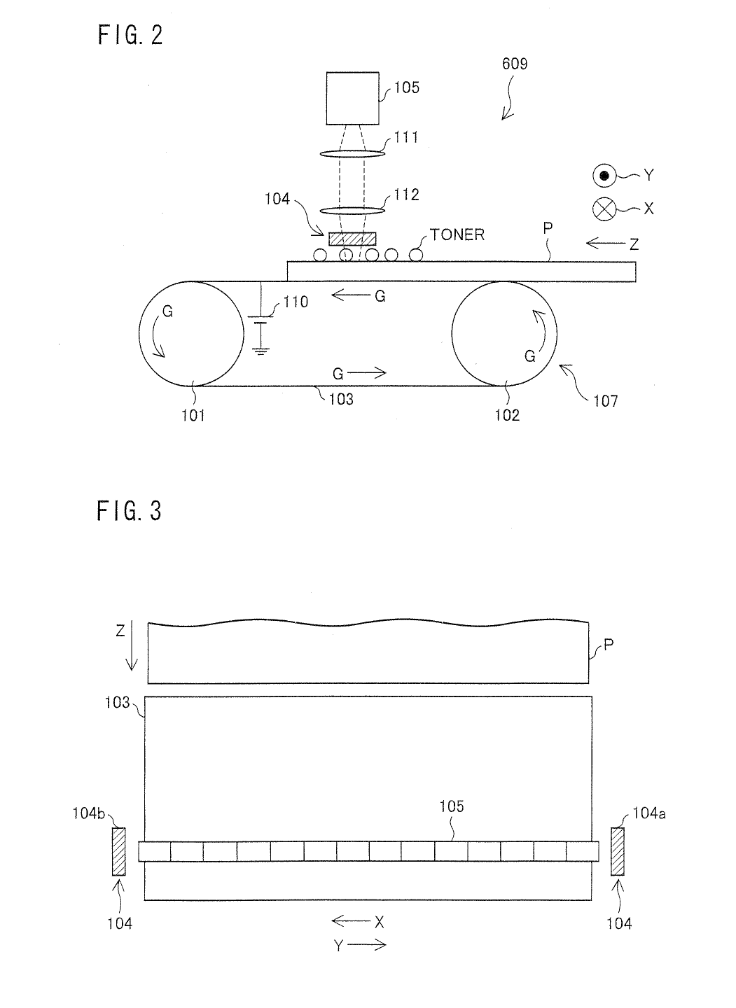

The following explains the fixing device 609 in detail. FIG. 2 is a drawing showing the fixing device 609 shown in FIG. 1 in an enlarged manner. The fixing device 609 radiates laser light to a toner image on the sheet P so as to fix the toner image on the sheet P. That is, the fixing device 609 is designed such that appropriate heat derived from a laser light power is applied to an unfixed toner layer on the sheet P, the toner layer is fused, and the fused toner layer is cooled down and fixed onto the sheet P. Thus, a solid image is formed.

As shown in FIG. 2, the fixing device (laser fixing device) 609 includes a laser array 105, a sheet conveying device 107, a transmission sensor 104, a collimator lens 111, and a converging lens 112. Further, as shown in FIG. 6, the fixing device 609 includes a fixing control section 602. The fixing control section 602 controls individual hardware included in the fixing device 609.

In the present embodiment, as shown in FIG. 2, a direction in which the sheet conveying device 107 conveys a sheet is regarded as a Z direction (sub-scanning direction). Further, as shown in FIGS. 2 and 3, a direction parallel to an edge of the paper which edge is perpendicular to a direction in which the paper is conveyed by the sheet conveying device 107 (front edge, rear edge) is regarded as a Y direction (first direction) and a direction parallel to but opposite to the Y direction is regarded as an X direction (second direction).

The sheet conveying device (conveying device) 107 includes tension rollers (rotating rollers) 101 and 102 and an endless belt 103. The shafts of the tension rollers 101 and 102 are connected with bearings (not shown). The tension roller 101 is connected with a driving section (not shown) via a gear (not shown), and is driven to rotate by the driving section. The tension roller 102 is caused to rotate by the rotation of the tension roller 101 and the endless belt 103.

The endless belt 103 is tensioned by the tension rollers 101 and 102. The endless belt 103 is made of a material obtained by dispersing a conductive material such as carbon into resin such as polycarbonate, vinylidene fluoride, polyamide imide, and polyimide (PI), and has heat-resistance.

Further, a power source (electrostatic attaching section) 110 applies a bias voltage to a back surface (inner surface) of the endless belt 103 so as to electrostatically attach the sheet P onto the surface (external surface) of the endless belt 103.

In the fixing device 609, the endless belt 103 is caused to rotate by the rotation of the tension roller 101. When the sheet P on which an image has been formed by the visible image forming unit 50 is conveyed to the fixing device 609, the sheet P is attached electrostatically to the endless belt 103 and conveyed in the Z direction, and passes through an area facing the laser array 105.

The laser array (laser radiating section) 105 radiates laser light to the sheet P in conveyance by the sheet conveying device 107, so that a toner image on the sheet P is fixed to the sheet P. With reference to FIGS. 2 and 3, the following explains the laser array 105 in detail. FIG. 3 is a drawing schematically showing the fixing device 609 viewed from a side where the laser array 105 is provided.

The laser array 105 includes a plurality of (approximately 1000) semiconductor laser elements. Specifically, the plurality of semiconductor laser elements are provided on the laser array 105 in such a manner as to be aligned in the X and Y directions.

Each of the semiconductor laser elements provided on the laser array 105 is a light source for radiating laser light of 780 nm in wavelength, and is switched between on and off by the fixing control section 602 shown in FIG. 6. Further, as shown in FIG. 2, between the semiconductor laser elements provided on the laser array 105 and the sheet P in conveyance, the collimator lens 111 and the converging lens 112 are positioned in this order with the collimator lens 111 being closer to the laser array 105. That is, laser light radiated from each of the semiconductor laser elements of the laser array 105 is changed to collimated light by the collimator lens 111, and then converged by the converging lens 112 to be focused on the surface of the sheet P. The area indicated by broken lines in FIG. 2 indicates a light path of laser light radiated from the laser array 105.

In the above configuration, the fixing control section 602 receives printing position information from the main body control section 601. The printing position information is information indicative of the position on a sheet P at which a toner image is formed by the image forming section 607. This information is generated by the main body control section 601 based on image data processed by the image processing section 606. The fixing control section 602 detects start of printing by receiving the printing position information, and stars driving of the fixing device 609. Specifically, when receiving the printing position information, the fixing control section 602 starts to drive the sheet conveying device 107. Subsequently, when the sheet P reaches the fixing device 609 and is conveyed to the area facing the laser array 105, the fixing control section 602 controls each of the semiconductor laser elements included in the laser array 105 to be switched between on and off based on the printing position information. Specifically, each of the semiconductor laser elements is switched between on and off so as to selectively radiate laser light to a position where a toner image is formed on the sheet P. Consequently, laser light is always radiated to a position where a toner image is formed on the sheet P, and laser light is not radiated to a position where the toner image is not formed on the sheet P. The toner image to which the laser light is radiated is heated and fused and consequently fixed to the sheet P.

The following specifically explains the transmission sensor (optical sensor) 104. In the present embodiment, when laser light from the laser array 105 is excessively radiated to the sheet P due to some abnormality (stop of sheet conveyance or mulfunction of a laser driving circuit), the sheet P or toner catches fire, and the fire generates smoke from the sheet P or the toner, the transmission sensor 104 detects generation of the smoke.

The transmission sensor 104 includes a light radiating device 104a and a light receiving device 104b. In the present embodiment, a laser sensor (LV-H300) manufactured by KEYENCE CORPORATION is used as the transmission sensor 104. However, the transmission sensor 104 is not limited to this and may be any well-known transmission sensor.

The light radiating device (light radiating section) 104a is a laser diode for radiating light (laser light) with a predetermined wavelength different from that of the laser light radiated from the semiconductor laser elements of the laser array 105. The light receiving device 104b receives only light having the same wavelength as that of the laser light radiated from the light emitting device 104a, and converts the received light into a voltage, thereby outputting a signal (electric signal) indicative of the amount of the received light having the wavelength. In the present embodiment, the predetermined wavelength is 650 nm.

As described above, the light from the transmission sensor 104 and the laser light from the laser array 105 have different wavelengths. Accordingly, even if the laser light from the laser array 105 is reflected and reaches the light receiving device 104b of the transmission sensor 104, the light receiving device 104b does not change its signal due to the laser light from the laser array 105.

Further, as shown in FIG. 3, the light radiating device 104a is positioned in the Y direction from the endless belt 103 and is positioned in the Y direction from the light path of laser light radiated from the laser array 105. The light receiving device (light receiving section) 104b is positioned in the X direction from the endless belt 103 and is positioned in the X direction from the light path of laser light radiated from the laser array 105. That is, the light radiating device 104a is positioned in the Y direction from a paper conveying path where a sheet with the maximum size dealt in the multifunctional printer 700 is conveyed, and the light receiving device 104b is positioned in the X direction from the sheet conveying path.

As shown in FIGS. 2 and 3, the light radiating device 104a and the light receiving device 104b are positioned in such a manner that the light radiating device 104a and the light receiving device 104b are closer to the laser array 105 (at an upper side) from the sheet conveying path of the sheet conveying device 107, and the light radiating device 104a and the light receiving device 104b face each other with the light path of the laser light from the laser array 105 therebetween. Further, the light radiating device 104a and the light receiving deice 104b are positioned in such a manner that an optical axis of the light from the light radiating device 104a cross the light-receiving plane of the light receiving device 104b and the optical axis is parallel to a direction in which the semiconductor laser elements of the laser array 105 are aligned.

Further, the light radiating device 104a and the light receiving device 104b are positioned in such a manner that the light path of the light traveling from the light radiating device 104a directly to the light receiving device 104b passes near the sheet P conveyed by the sheet conveying device 107. Specifically, the light radiating device 104a and the light receiving device 104b are positioned in such a manner that a gap between the light path of light traveling from the light radiating device 104a directly to the light receiving device 104b and the sheet P conveyed by the sheet conveying device 107 is in a range of 0.5 mm to 5 mm. Such positioning is made in order that when a sheet catches fire, smoke resulting from the fire surely and instantly passes through the light path from the light radiating device 104a to the light receiving device 104b.

Positioning the light radiating device 104a and the light receiving device 104b as above allows the light from the light radiating device 104a to pass through the light paths of all the semiconductor laser elements of the laser array 105 and to be received by the light receiving device 104b.

Further, the light radiating device 104a is designed to always radiate light during fixation of a toner image on the sheet P. The light receiving device 104b is designed to output a signal corresponding to the amount of received light having the same wavelength as that of the light radiated from the light radiating device 104a. Accordingly, the light receiving device 104b is designed to output a signal corresponding to the amount of light which is radiated from the light radiating device 104a and which can reach the light-receiving plane of the light receiving device 104b. The value of the signal output from the light receiving device 104b (hereinafter referred to as “output value”) is larger as the amount of light received by the light receiving device 104b (the amount of the received light with the predetermined wavelength) is larger.

In the present embodiment, in a case where the light with the predetermined wavelength is radiated from the light radiating device 104a to the light receiving device 104b while no object that blocks the light with the predetermined wavelength is positioned at the light path of the light with the predetermined wavelength, the output value of the light receiving device 104b is 5V.

On the other hand, in a case where the light receiving device 104b does not receive the light from the light radiating device 104a at all and at the same time does not receive light which is other than the light from the light radiating device 104a and which has the same wavelength as that of the light from the light radiating device 104a, the output of the light receiving device 104b is 0V.

That is, in a case where no object that blocks light from the light radiating device 104a exists at the light path from the light radiating device 104a to the light receiving device 104b, the light receiving device 104b outputs a signal of 5V. On the other hand, in a case where an object that blocks light from the light radiating device 104a exists at the light path from the light radiating device 104a to the light receiving device 104b, the output value of the light receiving device 104b is smaller as the amount of the blocked light is larger.

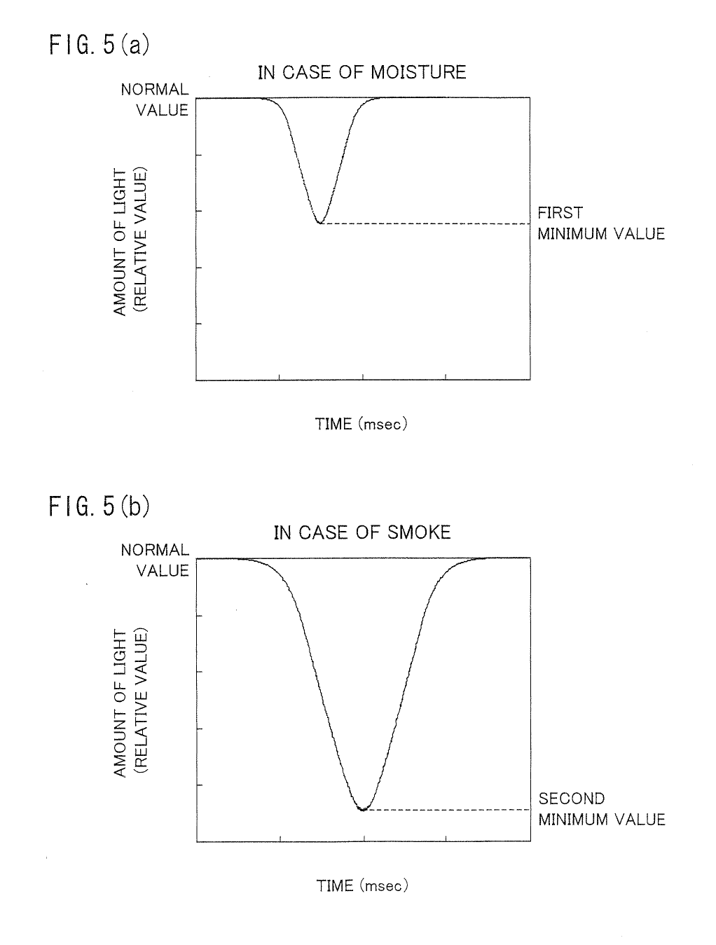

When smoke is emitted from the sheet P or toner as a result of firing of the sheet P or the toner, the smoke blocks the light from the light radiating device 104a. Consequently, when the smoke is generated, the output value of the light receiving device 104b (the amount of light received by the light receiving device 104b) is smaller than 5V, and it takes some time for the output value to return to 5V. Specifically, a relationship between the amount of light received by the light receiving device 104b and an elapsed time is shown in FIG. 5(b).

In the present embodiment, the fixing control section 602 is designed to monitor the output value of the light receiving device 104b and to regard the output value of 5V as a normal value. When the output value of the light receiving device 104b is the normal value (5V), the fixing control section 602 considers that the fixing device 609 is in a normal state. On the other hand, when the output value of the light receiving device 104b changes (gets smaller than the normal value) and does not return to the normal value (5V) after an elapse of a predetermined time from the start of the change, the fixing control section 602 determines that smoke is generated and compulsorily stops the laser array 105 to radiate laser light.

When the output value of the light receiving device 104b changes but the output value returns to the normal value (5V) within the predetermined time from the start of the change, the fixing control section 602 does not determine that smoke is generated and considers that the fixing device 609 is in a normal state. The reason is as follows: there is a case where light from the light radiating device 104a is blocked by a component volatilized from toner or a sheet even when smoke is not generated. In such a case, the output value changes but returns to the normal value in a shorter time than the case of the smoke. Accordingly, the fixing control section 602 is designed to consider that the fixing device 609 is not in a smoking state but in a normal state when the output value returns to the normal value (5V) within the predetermined time. With reference to drawings, the following explains this point by using a case where the volatilized component is moisture as an example. FIG. 5(a) is a graph showing a relationship between the amount of light received by the light receiving device 104b and the elapse of time in a case where moisture volatilized from toner blocks light from the light radiating device 104a. FIG. 5(b) is a graph showing a relationship between the amount of light received by the light receiving device 104b and the elapse of time in a case where smoke from a sheet blocks light from the light radiating device 104a. Comparison between FIG. 5(a) and FIG. 5(b) shows that it takes smaller time for the output value to return to the normal value in the case where the output value has changed due to moisture volatilized from the toner than in the case where the output value has changed due to smoke. Here, an explanation was made as to the case of moisture. Similarly, in a case of a component other than moisture which is volatilized from the toner, it takes smaller time for the output value to return to the normal value than in the case of smoke.

That is, the predetermined time is set to be longer than the time for the output value to change from the normal value and return to the normal value due to the volatilized component in the sheet or the toner, and to be shorter than the time for the output value to change from the normal value and return to the normal value due to smoke.

Since the fixing control section 602 operates as above, even if laser light is excessively radiated to the sheet P as a result of sudden stop of conveyance of a sheet due to jam etc. or mulfunction of a laser driving circuit and the excessive radiation sets fire on the sheet P or the toner and emits smoke, the fixing control section 602 can detect smoke and compulsorily stop the laser array 105 to radiate laser light.

The following explains a flow of processes carried out by the multifunctional printer 700 in a copy process. Initially, a user places a document on a document platen of the scanner 701 or an automatic document conveyance device. Next, when the user presses a copy button (not shown) on the input section 603, a printing instruction signal is sent to the main body control section 601. When receiving the printing instruction signal, the main body control section 601 causes the reading section 605 to read the document. Then, an image signal is sent from the reading section 605 to the image processing section 606, and the image signal is converted by the image processing section 606 into digital image data.

Thereafter, the image processing section 606 carries out an image process on the image data, and send the image data to the image forming section 607. Further, the image processing section 606 generates printing position information based on the image data, and send the printing position information to the fixing control section 602.

The image forming section 607 forms an image on the sheet P based on the image data sent from the image processing section 606, and conveys the sheet P on which the image is formed to the fixing device 609.

When receiving the printing position information, the fixing control section 602 starts to cause the fixing device 609 to operate. Specifically, the fixing control section 602 causes the driving section (not shown) to drive the endless belt 103 of the sheet conveying device 107, and makes the power source 110 on so as to apply a bias voltage to the endless belt 103. Further, when the sheet P is conveyed to the area facing the laser array 105, the fixing control section 602 controls the laser array 105 based on the printing position information so as to radiate laser light to the sheet P, thereby fixing an image on the sheet P. After fixing the image on the sheet P, the sheet P on which the image is fixed is sent to a discharge tray (not shown).

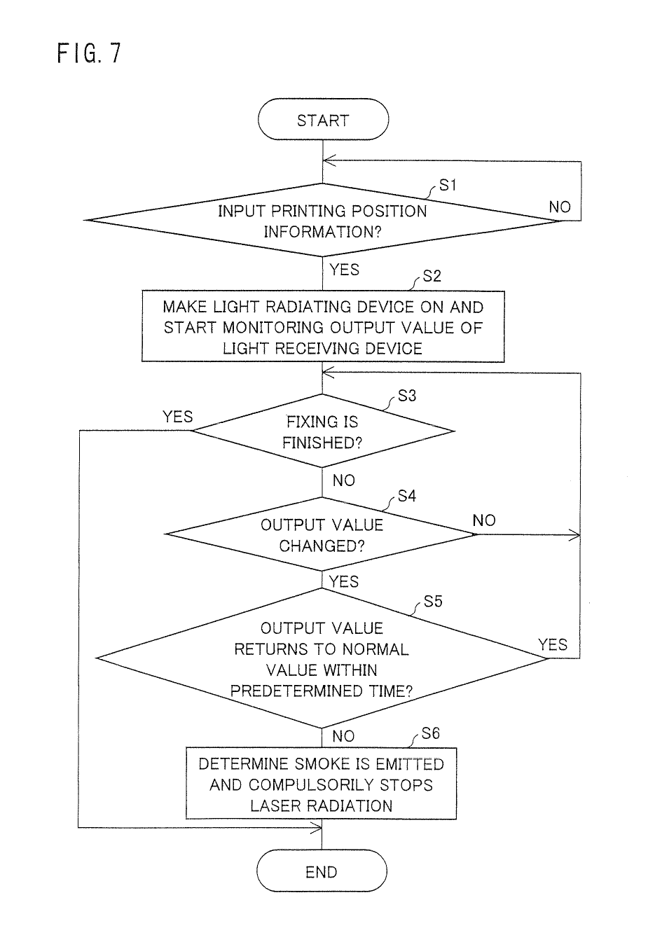

Further, in the fixing process, the fixing control section 602 determines whether smoke is emitted in the fixing device 609. When the fixing control section 602 determines that smoke is emitted in the fixing device 609, the fixing control section 602 stops the layer array 105 to radiate laser light. The flow of this process is explained below with reference to FIG. 7.

When the fixing control section 602 receives printing position information (YES in S1), the fixing control section 602 starts controlling the sheet conveying device 107 and the laser array 105, and makes the light radiating device 104a on, and starts to monitor an output value of the light receiving device 104b (S2). The fixing control section 602 continues to monitor the output value until the fixing process is completed.

When the fixing process is completed without a change of the output value from the normal value (5V), the fixing control section 602 finishes controlling the sheet conveying device 107 and the laser array 105 (NO in S3→NO in S4→YES in S3). When the output value changes from the normal value but returns to the normal value within a predetermined time and then the fixing process is completed, the fixing control section 602 finishes controlling the sheet conveying device 107 and the laser array 105 (YES in S4→YES in S5→YES in S3).

In contrast thereto, when the output value changes from the normal value and does not return to the normal value within the predetermined time in the fixing process, the fixing control section 602 determines that smoke is emitted and immediately and compulsory stops driving of the laser array 105 (YES in S4→NO in S5→S6). Further, along with compulsory supping of driving of the laser array 105, the fixing control section 602 also compulsory stops (i) application of a bias voltage on the endless belt 103 and (ii) driving of the endless belt 103. This allows swift and compulsory stopping of driving of the laser array 105 even if laser light is excessively radiated to the sheet P as a result of sudden stop of conveyance of a sheet due to jam etc. or mulfunction of a laser driving circuit and the excessive radiation sets fire on the sheet P or the toner and emits smoke. This subdues a burning rate of the sheet P, making it possible to set safety before a significant damage is caused.

As described above, the fixing device 609 of the present embodiment includes: the sheet conveying device 107; the laser array 105 for radiating laser light to the sheet P which is conveyed by the sheet conveying device 107 so that a toner image on the sheet P is fixed to the sheet P; the transmission sensor 104; and the fixing control section 602. The transmission sensor 104 includes the light radiating device 104a for radiating light with a predetermined wavelength and the light receiving device 104b for receiving the light with a predetermined wavelength so as to output a signal corresponding to the amount of the received light with a predetermined wavelength. The light radiating device 104a and the light receiving device 104b are positioned in such a manner that the light radiating device 104a and the light receiving device 104b face each other with a light path of the laser light from the laser array 105 therebetween, and light radiated from the light radiating device 104a crosses the light path of the laser light from the laser array 105 and then reaches the light receiving device 104b. The fixing control section 602 detects smoke based on the output signal of the light receiving device 104b.

With the arrangement of the fixing device 609, light radiated from the light radiating device 104a crosses the light path of laser light from the laser array 105 and then is received by the light receiving device 104b. At that time, if excessive radiation of laser light from the laser array 105 sets fire on the sheet P or toner on the sheet P and generates smoke, the smoke appears at the light path of laser light from the laser array 105. Consequently, the amount of light reaching from the light radiating device 104a to the light receiving device 104b decreases when the smoke is generated than when the smoke is not generated. Accordingly, when the smoke is generated, a signal value (output value) of the light receiving device 104b changes. Since the fixing device 609 of the present embodiment is designed to detect smoke based on the output value, the fixing device 609 can detect smoke with high accuracy.

Further, in the present embodiment, since the light path of light directly coming from the light radiating device 104a to the light receiving device 104b is positioned to be close to the sheet P conveyed by the sheet conveying device 107, it is possible to detect smoke promptly and with high accuracy.

Further, in the present embodiment, the fixing control section 602 is designed such that when the output value of the light receiving device 104b begins to change from a normal value and does not return to the normal value within a predetermined time, the fixing control section 602 determines that smoke is generated. This allows preventing wrongly determining that smoke is generated when the output value is changed not due to smoking by firing of the sheet P or toner but due to volatilization of a component contained in the sheet P or the toner, thereby increasing accuracy in detecting smoke.

Further, in the present embodiment, as shown in FIG. 3, the positional relationship between the light radiating device 104a and the light receiving device 104b is designed such that a traveling direction of light with the predetermined wavelength from the light radiating device 104a to the light receiving device 104b is parallel to the X direction and the Y direction. With the arrangement, provision of only one set of the light radiating device 104a and the light receiving device 104b allows the light with the predetermined wavelength traveling from the light radiating device 104a to the light receiving device 104b to cross light paths of all laser light sources included in the laser array 105. This allows reducing the number of members (light radiating device 104a and light receiving device 104b).

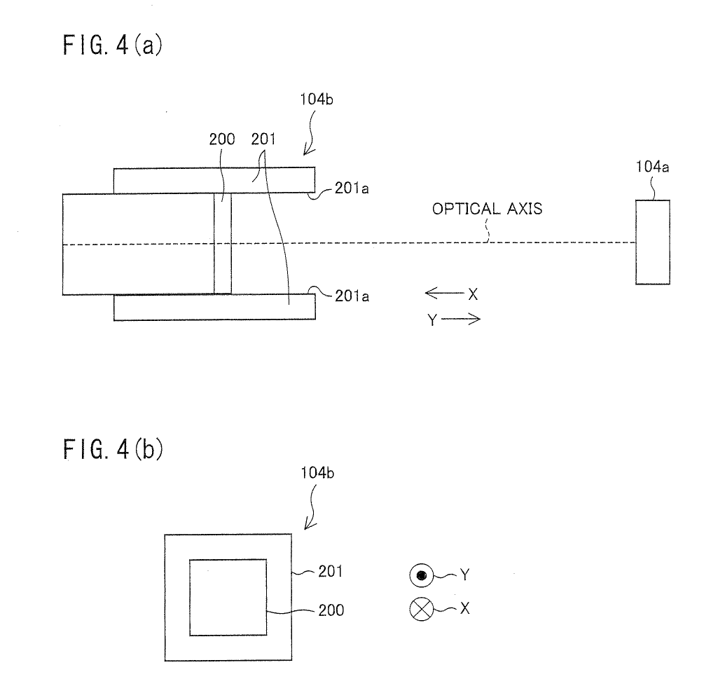

Further, as shown in FIGS. 4(a) and 4(b), the light receiving device 104b of the present embodiment includes a light-receiving plane 200 and a wall 201 surrounding the light-receiving plane 200. The light-receiving plane 200 is a plane for receiving light with a predetermined wavelength from the light radiating device 104a, and is perpendicular to an optical axis of the light from the light radiating device 104a. The wall 201 is designed to project from the light-receiving plane 200 toward the light radiating device 104a, and surrounds the light path of light directly reaching from the light radiating device 104a to the light-receiving plane 200. A facing plane 201a of the wall 201, which facing plane 201a faces the light path of light directly reaching from the light radiating device 104a to the light-receiving plane 200, is made of a light absorbing film which absorbs at least light with a predetermined wavelength (the same wavelength as that of light from the light radiating device 104a). With the arrangement, among light from the light radiating device 104a, stray light which does not directly reach the light receiving device 104b but is reflected by the sheet P etc. and then reach the light receiving device 104b can be absorbed by the facing plane 201a, so that it is possible to prevent the stray light from making the output value of the light receiving device 104b deviate from the normal value. Specifically, the wall 201 is made of a metal member such as aluminum and the light absorbing film is applied to a surface of the metal member which surface faces the light path. The light absorbing film may be black body painting.

Patent Literature 3 has a problem that flash light reflected by a sheet may be incident to a reflective sensor depending on a material used as the sheet or on the condition of toner on the sheet, resulting in wrong detection. In contrast thereto, in the present embodiment, the light receiving device 104b is designed as shown in FIG. 4 so as to output a signal corresponding to only an amount of light with a predetermined wavelength which directly reaches from the light radiating device 104a to the light receiving device 104b. Therefore, the above problem is not raised.

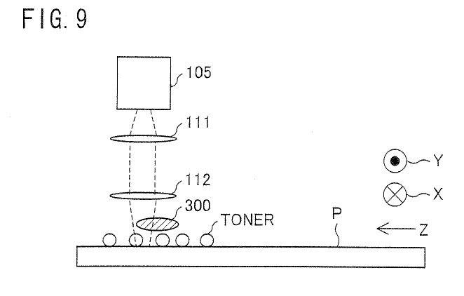

In a case where smoke is emitted from the sheet P conveyed in the Z direction, the smoke flows from a firing point of the sheet P toward upper stream in the Z direction. Consequently, smoke emitted from the sheet P due to excessive radiation of laser light tends to be distributed not only at an area where laser light passes through but also at an area where the laser light does not pass through and which is positioned at upper stream in the Z direction (sheet conveying direction) of the area where the laser light passes through. Accordingly, it is preferable to position the light radiating device 104a and the light receiving device 104b in such a manner that the light path of the light with a predetermined wavelength traveling from the light radiating device 104a to the light receiving device 104b is positioned not only at the area where the laser light from the laser array 105 passes through but also at the area where the laser light from the laser array 105 does not pass through and which is positioned at upper stream in the sheet conveying direction of the area where the laser light passes through. This positioning allows further increasing the accuracy in detecting smoke. Specifically, the light radiating device 104a and the light receiving device 104b are positioned in such a manner that the path of light with a predetermined wavelength traveling from the light radiating device 104a to the light receiving device 104b is positioned at an area indicated by a reference sign 300 in FIG. 9. In FIG. 9, the area surrounded by a broken line is an area where the laser light from the laser array 105 passes through.

When sheet jam occurs in the sheet conveying device 107, there is a case where the sheet P occupies a space between the light radiating device 104a and the light receiving device 104b depending on the condition of the jam (i.e. how the sheet is folded). Accordingly, the fixing control section (jam detecting section) 602 can detect sheet jam based on the output value of the light receiving device 104b. This is specifically explained below. When the space between the light radiating device 104a and the light receiving device 104b is occupied by the jamming sheet, the output value of the light receiving device 104b gets lower than when smoke is emitted from the sheet. That is, when smoke is emitted from the sheet, the output value drops to a second minimum value as shown in FIG. 5(b), whereas when the sheet jam occurs, the amount of received light is substantially zero, and so the output value drops to a value lower than the second minimum value. Accordingly, the present embodiment may be arranged such that a value lower than the second minimum value is set as a threshold and when the output value of the light receiving device 104b is lower than the threshold, the fixing control section 602 determines that the sheet jam occurs.

Further, in the present embodiment, there is provided the power source (electrostatic attaching section) 110 for electrostatically attaching the sheet P to the endless belt 103. The power source 110 prevents a sheet from lifting from the endless belt 103. This prevents the space between the light radiating device 104a and the light receiving device 104b from being occupied by the sheet P and thus prevents the output value from being changed. Consequently, it is possible to avoid wrong detection of smoke or sheet jam.

Since the sheet lifting is prevented, wrong detection due to the sheet lifting can be prevented even if the light emitting device 104a and the light receiving device 104b are positioned in such a manner that a light path of light from the light radiating device 104a to the light receiving device 104b passes near the sheet P. Accordingly, it is possible to detect smoke and sheet jam promptly and surely.

In the present embodiment, the fixing control section 602 determines that smoke is emitted when the output value of the light receiving device 104b changes from the normal value and does not return to the normal value after a predetermined time elapses from the change. Alternatively, the fixing control section 602 may determine by other method. For example, the fixing control section 602 may determine that smoke is emitted when the fixing control section 602 detects the minimum value while the output value changes and the minimum value is in a predetermined range. Alternatively, the fixing control section 602 may determine smoke is emitted when the fixing control section 602 detects the amount of decrease of the output value per unit time while the output value decreases and the decrease per unit time is in a predetermined range.

[Modification Example]

The output value of the light receiving device 104b exhibits a specific change pattern when smoke is emitted, and exhibits a specific change pattern with respect to each volatile component when a volatile compound contained in toner or sheet is volatilized. For example, the change pattern when smoke is emitted is as shown in FIG. 5(b), and the change pattern when moisture in toner or sheet is volatilized is as shown in FIG. 5(a).

In view of the above, the printer 703 is provided with a storage section (not shown) for storing, with respect to each volatile compound, pattern data indicative of a pattern of a change of the output value of the light receiving device 104b when the volatile component is volatilized from the sheet P or toner due to radiation of laser light from the laser array 105 to the sheet P and when smoke is not emitted. When the output value of the light receiving device 104b begins to change, the fixing control section 602 compares the pattern of the change and the pattern data so as to determine whether smoke is emitted or not.

Specifically, the fixing control section 602 detects the minimum value of the change pattern of the output value, and when the detected minimum value is identical with the minimum value of the pattern data (e.g. first minimum value in FIG. 5(a)) or within several % error range for the minimum value of the pattern data, the fixing control section 602 determines that the change pattern of the output value is identical with the pattern data, and does not determine that smoke is emitted. On the other hand, when there is no pattern data which is determined as being identical with the change pattern of the output value, the fixing control section 602 determines that smoke is emitted.

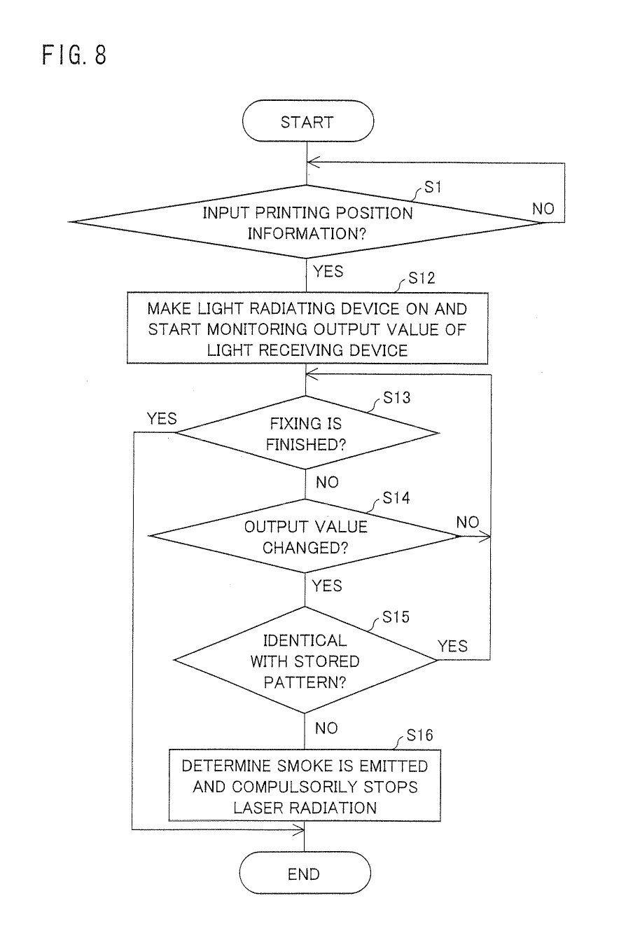

The following explains a flow of processes carried out by the fixing control section 602 in the present modification example with reference to FIG. 8. The processes up to S13 in FIG. 8 are the same as the processes up to S3 in FIG. 7 and therefore explanations thereof are omitted here.

In the present modification example, when the output value changes from the normal value in a fixing process (YES in S14), the fixing control section 602 compares a pattern of a change of an output value of the light receiving device 104b with individual pattern data stored in the storage section (S15).

When pattern data identical with the pattern of the change of the output value exists (YES in S15), the fixing control section 602 returns the process to S13, and repeats S13-S15 until the fixing process is finished. When the fixing process is finished (YES in S13), the fixing control section 602 finishes a process of monitoring the output value of the light receiving device 104b, too.

On the other hand, when pattern data identical with the pattern of the change of the output value does not exist in S15, the fixing control section 602 determines that smoke is emitted and immediately and compulsory stops operation of the laser array 105 (S16). Along with the compulsory stop of the operation of the laser array 105, the fixing control section 602 compulsory stops application of a bias voltage to the endless belt 103, and compulsory stops the operation of the endless belt 103.

Also by the above procedure shown in FIG. 8, it is possible to distinguish when smoke is emitted from when a volatile component is volatilized. Accordingly, it is possible to improve accuracy in detecting smoke.

The procedure explained above is a procedure to compare the minimum value of the pattern of the change of the output value with the minimum value of the pattern data, but the present embodiment is not limited to this procedure. For example, the present embodiment may be arranged such that a time for the output value to return to the normal value in the pattern of the change of the output value is compared with a time for the output value to return to the normal value in the pattern data. Alternatively, the present embodiment may be arranged such that the amount of decrease in the output value per unit time in the pattern of the change of the output value is compared with the amount of decrease in the output value per unit time in the pattern data.

The fixing device 609 of the present embodiment is a laser array fixing device which radiates laser light to a sheet by a laser array. The present invention is applicable to a scanning fixing device which causes laser light to be reflected by a polygon mirror and to scan a sheet. However, the scanning fixing device requires causing laser light to scan a sheet not only in a direction in which the sheet is conveyed but also in a direction perpendicular to the direction in which the sheet is conveyed (i.e. width direction of the endless belt 103), and thus requires a time for the fixing process. Consequently, when the scanning fixing device is applied to an image processing apparatus with a high process speed, there is a possibility that fixing is made insufficiently. Further, the scanning fixing device has a complicated structure, which requires high cost. In contrast thereto, the laser array fixing device does not require causing laser light to scan a sheet both in a sheet conveying direction and a direction vertical to the sheet conveying direction. Accordingly, the laser scanning fixing device may have a minimum space as required and is capable of carrying out a high-speed fixing process.

The processes in FIGS. 7 and 8 are carried out not in a copy process but also in a printing process (when a user enters a printing instruction via a screen of a printer driver of a terminal device).

The following explains advantages of the present embodiment compared to prior arts. Patent Literature 1 does not consider overcoming problems such as firing of a recording sheet or a damage to a recording sheet conveying device which is due to intensive heating to the recording sheet conveying device (excessive heating of the recording sheet) caused, for example, when radiation of laser light from the fixing device is carried out in a wrong manner. Heating by laser light instantly heats a recording sheet, and therefore it is necessary to stop heating instantly when smoke is emitted. However, Patent Literature 1 does not consider this point. Further, in Patent Literature 3, when scattered light is incident to a light receiving section, smoke can be detected, but it is uncertain whether the scattered light is surely incident to the light receiving section. Therefore, Patent Literature 3 has a problem in terms of detection accuracy. Further, in a case where the width of radiated light is wide as in a flash fixing method, it is necessary to provide a plurality of sensors in order that scattered lights in individual radiation areas are detected. In contrast thereto, in the present embodiment, the transmission sensor 104 is provided near an area where light is radiated on a sheet, so that the transmission sensor 104 can instantly detect when the paper catches fire and smoke is emitted. Accordingly, it is possible to immediately stop radiation of light before the fire broadens. Further, since the transmission sensor 104 is provided near the sheet, it is possible not only to detect smoke but also to immediately detect a foreign matter or sheet jam occurred while a sheet is conveyed. Further, unlike Patent Literature 2, it is unnecessary to provide a duct separately.

Further, in the present embodiment, it is possible to detect smoke in radiation ranges of all laser light sources of the laser array 105 by only one transmission sensor 104. In contrast thereto, in the flash fixing method of Patent Literature 3, lights from a plurality of flash lamps are radiated to the whole sheet, and therefore it is impossible for one sensor to cover the whole radiated areas, unlike the present embodiment.

The functions of the fixing control section 602 of the present embodiment may be realized by software. That is, the multifunctional printer 700 includes a computer including a processor (CPU or MPU) which executes instructions in programs, a ROM (read only memory) which contains the programs, a RAM (random access memory) to which the programs are loaded, and a storage device (storage medium) such as a memory containing the programs and various data.

The functions of the fixing control section 602 can be achieved by mounting to the multifunctional printer 700 a storage medium containing a program code (executable program, intermediate code program, or source program) which is software for realizing the functions of the fixing control section 602, in order for a processor such as CPU (Central Processing Unit) to retrieve and execute the program code contained in the storage medium.

The storage medium is a computer-readable one, and may be, for example, a tape, such as a magnetic tape or a cassette tape; a magnetic disk, such as a floppy® disk or a hard disk, or an optical disk, such as CD-ROM/MO/MD/DVD/CD-R/blu-ray disc; a card, such as an IC card (memory card) or an optical card; or a semiconductor memory, such as a mask ROM/EPROM/EEPROM/flash ROM.

The multifunctional printer 700 may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth®, 802.11 wireless, HDR, mobile telephone network, satellite line, or terrestrial digital network.

The present invention is not limited to the description of the embodiments above, but may be altered by a skilled person within the scope of the claims. An embodiment based on a proper combination of technical means disclosed in different embodiments is encompassed in the technical scope of the present invention.

### Summary of Embodiment

A laser fixing device of the present embodiment includes: a conveying device for conveying a sheet; a laser radiating section for radiating laser light to a sheet conveyed by the conveying device so that a toner image on the sheet is fixed to the sheet; an optical sensor including a light radiating section for radiating light with a predetermined wavelength and a light receiving section for receiving the light with a predetermined wavelength so as to output a signal corresponding to a received amount of the light with a predetermined wavelength, the light radiating section and the light receiving section being positioned in such a manner that the light radiating section and the light receiving section face each other with a light path of the laser light therebetween, and light radiated from the light radiating section crosses the light path of the laser light and then reaches the light receiving section; and a smoke detecting section for detecting smoke in the laser fixing device based on the signal. With the arrangement, light radiated from the light radiating section crosses the light path of the laser light and then reaches the light receiving section. When smoke is emitted from the sheet due to excessive radiation of laser light, smoke appears at the light path of the laser light. Consequently, the amount of light decreases when smoke is emitted than when smoke is not emitted. Therefore, when smoke is emitted from the sheet, the signal output from the light receiving section changes. Since the present invention is designed to detect smoke based on the signal, the present invention allows detecting smoke with high accuracy.

In a normal state, the value of the signal indicates the normal value, whereas when a component contained in the sheet or toner is volatilized by radiation of the laser light, the value of the signal tends to change from the predetermined normal value and then return to the normal value. It takes more time for the value of the signal to return to the normal value when the value of the signal changes due to smoke than when the value of the signal changes due to volatilization. Therefore, it is preferable to arrange the laser fixing device of the present embodiment such that the smoke detecting section determines that smoke is emitted when the signal output from the light receiving section begins to change from a normal value and does not return to the normal value within a predetermined time from beginning of the change, the normal value being defined as a value of the signal when the light with a predetermined wavelength is radiated from the light radiating section while no object which blocks the light with a predetermined wavelength exists in the light path of the light with a predetermined wavelength. With the arrangement, it is possible to prevent wrongly determining that smoke is emitted when in fact the value of the signal changes not due to smoke but due to volatilization of the component contained in the sheet or the toner. Thus, accuracy in detecting smoke is improved.

It is preferable to arrange the laser fixing device of the present embodiment to further include a storage section for storing pattern data indicative of a pattern of a change of a value of the signal when radiation of laser light from the laser radiating section to a sheet volatilizes a volatile component from the sheet or toner on the sheet and when no smoke is emitted, when a value of the signal output from the light receiving section begins to change, the smoke detecting section compares a pattern of the change with the pattern data so as to determine whether smoke is emitted or not. With the arrangement, it is possible to prevent wrongly determining that smoke is emitted when in fact the value of the signal changes not due to smoke but due to volatilization of the component contained in the sheet or the toner. Thus, accuracy in detecting smoke is improved.

The laser fixing device of the present embodiment may be arranged such that the light radiating section is positioned in a first direction from a path via which a sheet is conveyed by the conveying device, and the light receiving section is positioned in a second direction from the path, the first direction being defined as a direction parallel to an edge of the paper which edge is perpendicular to a direction in which the paper is conveyed by the conveying device and the second direction being defined as a direction parallel to but opposite to the first direction. In this arrangement, it is preferable to arrange the laser fixing device of the present embodiment such that the laser radiating section is a laser array consisting of a plurality of laser light sources aligned along the second direction, and the light radiating section and the light receiving section are positioned in such a manner that a traveling direction of the light with a predetermined wavelength from the light radiating section to the light receiving section is parallel to the second direction. With the arrangement, provision of only one set of the light radiating section and the light receiving section allows the light traveling from the light radiating section to the light receiving section to cross light paths of all laser light sources. This allows reducing the number of members (light radiating section and light receiving section).

In a case where smoke is emitted from the sheet in conveyance, the smoke flows from a firing point of the sheet toward upper stream in the sheet conveying direction. Consequently, smoke emitted from the sheet due to excessive radiation of laser light tends to be distributed not only at an area where laser light passes through but also at an area where the laser light does not pass through and which is positioned at upper stream in the sheet conveying direction of the area where the laser light passes through. Accordingly, it is preferable to arrange the laser fixing device of the present embodiment such that the light radiating section and the light receiving section are positioned such that a light path of the light with a predetermined wavelength from the light radiating section to the light receiving section passes through a laser-light-passing area where the laser light passes and a non-laser-light-passing area where the laser light does not pass and which is positioned upperstream from the laser-light-passing area in a direction in which the sheet is conveyed. This positioning allows further increasing the accuracy in detecting smoke.

It is preferable to arrange the laser fixing device of the present embodiment such that the light receiving section includes: a light-receiving plane for receiving the light with a predetermined wavelength; and a wall formed to project from the light-receiving plane toward the light radiating section, the wall having a facing plane which faces a light path of light from the light radiating section to the light-receiving plane, the facing plane being made of a light absorbing film for absorbing the light with a predetermined wavelength. With the arrangement, among light from the light radiating section, stray light which does not directly reach the light receiving section but is reflected by the sheet etc. and then reach the light receiving section can be absorbed, so that it is possible to prevent the stray light from making the output value of the light receiving section deviate from the normal value.

When sheet jam occurs, there is a case where the sheet occupies a space between the light radiating section and the light receiving section depending on the condition of the jam (i.e. how the sheet is folded). Accordingly, the laser fixing device of the present embodiment may be arranged so as to further include a jam detecting section for detecting sheet jam based on the signal output from the light receiving section. With the arrangement, it is possible to detect the jam based on the signal output from the light receiving section.

It is preferable to arrange the laser fixing device of the present embodiment may be arranged such that the conveying device includes rotation rollers and an endless belt which is tensioned by the rotation rollers and which rotates in accordance with rotation of the rotation rollers, and the conveying device conveys a sheet when the sheet is placed on the endless belt, the laser fixing device further comprising an electrostatic attaching section for electrostatically attaching the sheet to the endless belt. With the arrangement, it is possible to prevent sheet lifting from the endless belt. This prevents the space between the light radiating section and the light receiving section from being occupied by the sheet and thus prevents the output value from being changed. Consequently, it is possible to avoid wrong detection of smoke or sheet jam.

The laser fixing device of the present embodiment is placed in an electrophotographic image forming apparatus. Examples of the image forming apparatus include a multifunctional printer, a copying machine, a printer, and a facsimile.

### INDUSTRIAL APPLICABILITY

The present invention is applicable to a laser fixing device placed in an electrophotographic image forming apparatus. Examples of the image forming apparatus include a multifunctional printer, a copying machine, a printer, and a facsimile.

### Reference Signs List

101: tension roller (rotation roller)
102: tension roller (rotation roller)
103: endless belt
104: transmission sensor (optical sensor)
104a: light radiating device (light radiating section)
104b: light receiving device (light receiving section)
105: laser array (laser radiating section)
107: sheet conveying device (conveying device)
110: power source (electrostatic attaching section)
200: (light receiving plane)
201: wall
201a: facing plane
602: fixing control section (smoke detecting section, jam detecting section)
609: fixing device (laser fixing device)
700: multifunctional printer (image forming apparatus)

1. A laser fixing device, comprising:
a conveying device for conveying a sheet;
a laser radiating section for radiating laser light to a sheet conveyed by the conveying device so that a toner image on the sheet is fixed to the sheet;
an optical sensor including a light radiating section for radiating light with a predetermined wavelength and a light receiving section for receiving the light with a predetermined wavelength so as to output a signal corresponding to a received amount of the light with a predetermined wavelength, the light radiating section and the light receiving section being positioned in such a manner that the light radiating section and the light receiving section face each other with a light path of the laser light therebetween, and light radiated from the light radiating section crosses the light path of the laser light and then reaches the light receiving section; and
a smoke detecting section for detecting smoke in the laser fixing device based on the signal.

2. The laser fixing device as set forth in claim 1, wherein the smoke detecting section determines that smoke is emitted when the signal output from the light receiving section begins to change from a normal value and does not return to the normal value within a predetermined time from beginning of the change,
the normal value being defined as a value of the signal when the light with a predetermined wavelength is radiated from the light radiating section while no object which blocks the light with a predetermined wavelength exists in the light path of the light with a predetermined wavelength.

3. The laser fixing device as set forth in claim 1, further comprising a storage section for storing pattern data indicative of a pattern of a change of a value of the signal when radiation of laser light from the laser radiating section to a sheet volatilizes a volatile component from the sheet or toner on the sheet and when no smoke is emitted,
when a value of the signal output from the light receiving section begins to change, the smoke detecting section compares a pattern of the change with the pattern data so as to determine whether smoke is emitted or not.

4. The laser fixing device as set forth in claim 1, wherein the light radiating section is positioned in a first direction from a path via which a sheet is conveyed by the conveying device, and the light receiving section is positioned in a second direction from the path, the first direction being defined as a direction parallel to an edge of the paper which edge is perpendicular to a direction in which the paper is conveyed by the conveying device and the second direction being defined as a direction parallel to but opposite to the first direction.

5. The laser fixing device as set forth in claim 4, wherein the laser radiating section is a laser array consisting of a plurality of laser light sources aligned along the second direction, and
the light radiating section and the light receiving section are positioned in such a manner that a traveling direction of the light with a predetermined wavelength from the light radiating section to the light receiving section is parallel to the second direction.

6. The laser fixing device as set forth in claim 1, wherein the light radiating section and the light receiving section are positioned in such a manner that a light path of the light with a predetermined wavelength from the light radiating section to the light receiving section passes through a laser-light-passing area where the laser light passes and a non-laser-light-passing area where the laser light does not pass and which is positioned upperstream from the laser-light-passing area in a direction in which the sheet is conveyed.

7. The laser fixing device as set forth in claim 1, wherein the light receiving section includes:
a light-receiving plane for receiving the light with a predetermined wavelength; and
a wall formed to project from the light-receiving plane toward the light radiating section, the wall having a facing plane which faces a light path of light from the light radiating section to the light-receiving plane,
the facing plane being made of a light absorbing film for absorbing at least the light with a predetermined wavelength.

8. The laser fixing device as set forth in claim 1, further comprising a jam detecting section for detecting sheet jam based on the signal output from the light receiving section.

9. The laser fixing device as set forth in claim 1, wherein
the conveying device includes rotation rollers and an endless belt which is tensioned by the rotation rollers and which rotates in accordance with rotation of the rotation rollers, and the conveying device conveys a sheet when the sheet is placed on the endless belt,
the laser fixing device further comprising an electrostatic attaching section for electrostatically attaching the sheet to the endless belt.

10. An image forming apparatus, comprising a laser fixing device,
said laser fixing device including:
a conveying device for conveying a sheet;
a laser radiating section for radiating laser light to a sheet conveyed by the conveying device so that a toner image on the sheet is fixed to the sheet;
an optical sensor including a light radiating section for radiating light with a predetermined wavelength and a light receiving section for receiving the light with a predetermined wavelength so as to output a signal corresponding to a received amount of the light with a predetermined wavelength, the light radiating section and the light receiving section being positioned in such a manner that the light radiating section and the light receiving section face each other with a light path of the laser light therebetween, and light radiated from the light radiating section crosses the light path of the laser light and then reaches the light receiving section; and
a smoke detecting section for detecting smoke in the laser fixing device based on the signal.
